(19) United States
(12) Patent Application Publication
(10) Pub. No.: US 2026/0234869 A1
(43) Pub. Date: Aug. 13, 2026

(54) Method for Producing a Composite Material that is Free of Melamine-Formaldehyde Resin

(71) Applicant: Flooring Technologies Ltd., Kalkara (MT)

(72) Inventors: Joachim Hasch, Berlin (DE); Norbert Kalwa, Horn-Bad Meinberg (DE); Roger Braun, Willisau (CH)

(21) Appl. No.: 19/156,921

(22) PCT Filed: Feb. 15, 2024
(86) PCT No.: PCT/EP2024/053860

§ 371 Date: Aug. 15, 2025

(30) Foreign Application Priority Data
Feb. 17, 2023 (EP) 23157363.5

(51) Int. Cl. D21H 17/57; D21H 27/24; D21H 27/26

(52) U.S. Cl. CPC D21H 17/57; D21H 27/24; D21H 27/26

(57) ABSTRACT

A process for producing a composite material free of melamine-formaldehyde resin including at least one carrier material, at least one polymer layer or lacquer layer provided on the upper side of the carrier material and at least one resin-containing layer provided on the underside of the carrier material, including providing at least one carrier material, applying at least one layer of a urea-formaldehyde resin to the carrier material, applying at least one layer of a thermoplastic elastomer to the carrier material, applying at least one melamine-free resin-containing layer to the underside of the carrier material, and drying and pressing the layer structure. Instead of a thermoplastic elastomer, a lacquer can be applied after pressing.

### CROSS-REFERENCE TO RELATED APPLICATIONS

This application is the United States national phase of International Patent Application No. PCT/EP2024/053860 filed Feb. 15, 2024, and claims priority to European Patent Application No. 23157363.5 filed Feb. 17, 2023, the disclosures of each of which are hereby incorporated by reference in their entireties.

### BACKGROUND

### Technical Field

The present disclosure relates to a process for producing a composite material free of melamine-formaldehyde resin and to a melamine-free composite material produced by this process.

### Technical Considerations

Melamine resin surfaces have been used for decades in a wide variety of applications. These surfaces are often used where high demands are placed on good cleanability and disinfectability. A particular advantage here is that melamine surfaces are not a good growth substrate for bacteria per se. Further advantages are that the chemical and mechanical resistance is very high. The melamine layer also provides an effective barrier against outgassing from the carrier boards. These advantages of melamine resin surfaces are used for example for laminate flooring and furniture surfaces.

However, the potential negative properties of melamine itself for the environment are currently being discussed. These include its persistence (poor biodegradability) and its mobility after release. Although melamine can only be detected in harmless traces in melamine resin surfaces, the above-mentioned discussion naturally leads to uncertainty in the market.

Another problem is that alternative materials are either not available in the required quantities, are not as efficient in terms of their properties and/or cannot be processed on the production lines currently available (e.g. short-cycle presses, laminate presses, etc.). The same also applies to the purchasers of the coated panels, who have naturally also taken into account the good mechanical properties during transportation through processing lines etc. during processing.

Unfortunately, the idea of covering the finished melamine resin surface with a thin protective layer after production is also not expedient, as this protective layer could be quickly removed by abrasion when walking on it (laminate flooring) or disinfecting it (furniture surfaces). Furthermore, this would not be a solution for the melamine dust that occurs during processing.

In addition to melamine resin, a whole range of resins are known that are used to impregnate paper for decorative applications. However, these synthetic resins have disadvantages that make it impossible to use them as a single resin.

Urea-formaldehyde resins are used individually or in a mixture with melamine-formaldehyde resins for core impregnation, for example. However, they have the disadvantage that these resins do not flow into a film during the further processing of impregnates in short-cycle presses. In addition, urea-formaldehyde resins are susceptible to hydrolysis and are not chemically resistant.

Another synthetic resin that is used for various applications is phenol-formaldehyde resin. This resin, which has a light brown to medium brown color, is used for the impregnation of core layers of laminates or for underlay sheets. However, due to its inherent color, it cannot be used to impregnate the surfaces of decorative papers. In addition, the color of the resin deepens when exposed to sunlight. Furthermore, direct contact of phenolic impregnates with foodstuffs must be ruled out.

Another resin system that could be used is acrylate resin. However, when used alone on paper, this provides a brittle impregnate that cannot be processed in a short-cycle press.

An alternative for surfaces that are not subject to very high mechanical and chemical stresses are so-called finish foils. These are decorative products with a core impregnation of urea-formaldehyde resin and acrylate resin, which are coated on the top (UV or ESH lacquer). These films are laminated onto wood-based substrates on laminating lines. Compared to melamine surfaces, they have significantly poorer properties, meaning that they are not suitable for heavy-duty or highly stressed applications. Processing on short-cycle presses is also not possible.

### SUMMARY

The present disclosure is therefore based on the technical object of overcoming the disadvantages resulting from the reclassification. The product should be free of melamine through the use of alternative resins or films. For this purpose, a composite material, e.g. in the form of an impregnate, is to be developed which, after processing on a short-cycle press and continuously operating presses, results in products that have approximately the property profile of a melamine surface. It should be possible to produce the impregnate on the existing impregnation channels. Further processing should also be possible on short-cycle presses and continuous presses without technological or technical changes. The costs of the product should not change significantly.

According to the present disclosure, this object is solved by processes having features as described herein and a composite material produced thereby.

According to a first non-limiting aspect, there is provided a process for producing a composite material free of melamine-formaldehyde resin comprising at least one carrier material, at least one polymer layer provided on the upper side of the carrier material and at least one resin-containing layer provided on the underside of the carrier material, the process comprising:
Providing at least one carrier material,
Applying at least one layer of a urea-formaldehyde resin to the carrier material,
Applying at least one layer of a thermoplastic elastomer to the upper side of the carrier material,
Applying at least one melamine-free resin-containing layer to the underside of the carrier material, and
Drying and pressing the layered structure.

A process is thus provided for producing a composite material for use in flooring laminates or furniture elements in which the use of melamine-formaldehyde resin can be completely omitted. For example, the surface layers provided on the carrier material (i.e. layers on the top and bottom of the carrier material) have no melamine-formaldehyde resin. Surprisingly, the composite materials produced by the present process meet the requirements necessary for floor coverings, as shown in the embodiment examples.

The order in which the layer of thermoplastic elastomer is applied to the upper side of the carrier material and the resin-containing layer is applied to the underside of the carrier material can be flexible and variable, i.e. it is possible to first apply the thermoplastic elastomer to the upper side of the carrier material and then apply the melamine-free resin-containing layer to the underside of the carrier material or to first apply the melamine-free resin-containing layer to the underside of the carrier material and then apply the thermoplastic elastomer to the upper side of the carrier material. It is also possible to apply the thermoplastic elastomer to the upper side and the melamine-free resinous layer to the underside at the same time. The sequence depends on the respective production lines.

For the purposes of the present disclosure, the term “thermoplastic elastomers” refers to plastics which behave similarly to classic elastomers at room temperature, but which can be plastically deformed when heat is applied and thus exhibit thermoplastic behavior. Thermoplastic elastomers are materials in which elastic polymer chains are integrated into thermoplastic material. They can be processed in a purely physical process involving a combination of high shear forces, heat and subsequent cooling. Although no chemical cross-linking through time-consuming and temperature-intensive vulcanization is necessary as with elastomers, the parts produced have rubber-elastic properties due to their special molecular structure. Renewed exposure to heat and shear force causes the material to melt and deform again. However, this also means that the thermoplastic elastomers are far less thermally and dynamically resilient than standard elastomers. Thermoplastic elastomers are therefore not a “successor product” to conventional elastomers, but a supplement that combines the processing advantages of thermoplastics with the material properties of elastomers. Well-known thermoplastic elastomers are thermoplastic polyamide elastomers (TPA), thermoplastic copolyesters (TPC), thermoplastic styrene block copolymers (TPS), olefin-based thermoplastic elastomers (TPO) or thermoplastic urethanes (TPU) (see Wikipedia “Thermoplastic elastomers”).

For the purposes of the present disclosure, thermosetting resins, and here preferably melamine-free formaldehyde resins, are used as resins.

It is also possible not to use a thermoplastic elastomer to coat the surface, but to use a lacquer layer instead, whereby this lacquer layer is applied to the upper side or surface of the carrier material after the layer structure has been pressed.

According to a second non-limiting aspect, there is provided a process for producing a composite material free of melamine-formaldehyde resin comprising at least one carrier material, at least one lacquer layer provided on the upper side of the carrier material and at least one resin-containing layer provided on the underside of the carrier material, the method comprising:
Providing at least one carrier material,
Applying at least one layer of a urea-formaldehyde resin to the carrier material,
Applying at least one melamine-free resin-containing layer to the underside of the carrier material, and
Drying and pressing of the layer structure;
Applying at least one layer of lacquer to the upper side of the pressed layer structure.

For the purposes of the present disclosure, the term “lacquer” is to be understood as a liquid or powdery coating material that is applied thinly to objects and is built up into a continuous, solid film by chemical or physical processes (e.g. evaporation of the solvent). Coatings usually consist of binders such as resins, dispersions or emulsions, fillers, pigments, solvents and additives (see Wikipedia “Lacquer”).

### DETAILED DESCRIPTION

### Paper Layer as Carrier Material

In one non-limiting embodiment of the present process, the at least one carrier material is a paper layer, preferably a decorative paper layer.

Accordingly, according to the first non-limiting aspect, the present process may comprise:
Providing at least one layer of paper,
Applying at least one layer of a urea-formaldehyde resin to the paper layer to impregnate the paper layer,
Applying at least one layer of a thermoplastic elastomer, for example thermoplastic polyurethane, to the upper side of the impregnated paper layer,
Applying at least one melamine-free resin-containing layer as an adhesive layer on the underside of the impregnated paper layer, and
Drying and pressing of the layer structure.

The paper layers used here, for example decorative paper layers, have a paper weight of 60 to 120 g/m², preferably 80 g/m².

Decor papers are specialty papers for surface finishing of wood-based materials that allow for a wide variety of decors. In addition to the typical imprints of various wood structures, further imprints of geometric shapes or artistic, decorative designs are available. There is virtually no restriction in the choice of motifs. To ensure optimum printability, the paper used must have good smoothness and dimensional stability and also be suitable for penetration of any necessary synthetic resin impregnation.

As mentioned, a urea-formaldehyde resin is first applied to the carrier material. If paper layers are used as the carrier material, the paper layer is partially or completely impregnated with the urea-formaldehyde resin, whereby the urea-formaldehyde resin penetrates or permeates into the paper layer. In the present case, the term “impregnation” means complete or partial impregnation of the paper layer with the resin. The urea resin used here is used for the so-called core impregnation of the paper. This means that melamine-free paper layers are used as a carrier material.

In one non-limiting variant, the liquid application amount of the urea-formaldehyde resin is of 100 to 250 g/m², preferably of 130 to 200 g/m², more preferably of 150 to 180 g/m², such as 160 g/m². The solid application amount of urea-formaldehyde resin is of 50 to 125 g/m², preferably of 65 to 100 g/m², more preferably of 75 to 90 g/m², such as 80 g/m².

The urea-formaldehyde resin used for core impregnation is supplemented with the usual additives such as hardeners, wetting agents (surfactants or mixtures thereof), release agents and/or other components.

In the production of the impregnates, the urea resin is applied in an impregnation tank where, after immersion in the impregnation tank, the resin is scraped off to a defined resin application using doctor blades or squeeze rollers. The impregnate is then dried in a flash dryer with hot air, e.g. to a residual moisture content of 20% by weight.

A corresponding impregnation system includes:
Optional paper unwinding and changing device,
an impregnation station for pre-impregnating (core impregnation) at least one layer of paper with a urea-formaldehyde resin, and
a first drying station.

Specifically, the impregnation system comprises impregnation tanks or impregnation dipping baths (as impregnation stations), possibly a breathing section, a doctor blade system/pair of squeeze rollers for removing excess resin, at least one dryer (e.g. a floating dryer), optionally an anilox, optionally a powder scatterer and optionally a second dryer, at least one cooling device (e.g. a cooling roller system).

After the core impregnation, the thermoplastic elastomer, for example thermoplastic polyurethane, can be applied to the paper layer in a next step. In this case, a dispersion of a thermoplastic elastomer with a solids content of 20 to 60% by weight, preferably of 30 to 50% by weight, for example 40% by weight, is used. The application quantity of the thermoplastic elastomer is of 50 to 150 g/m²fl, preferably of 70 to 130 g/m²fl, more preferably of 90 to 110 g/m²fl, such as 100 g/m²fl. The amount of thermoplastic elastomer applied is approx. of 30 to 50% by weight relative to the paper weight.

The application of the thermoplastic elastomer as a liquid application (in the form of a dispersion) enables the thermoplastic elastomer to be applied in variable quantities, in contrast to the use of films made of thermoplastic elastomer, which can only be used with predetermined film grammages (film quantities).

As already indicated, thermoplastic polyurethane is preferably used here as a thermoplastic elastomer, for example as a surface layer.

Thermoplastic polyurethane (TPU) belongs to a class of polyurethanes-plastics with many properties, such as high abrasion resistance, low temperature performance, high shear strength, high elasticity, transparency, oil and grease resistance.

TPU is a block copolymer consisting of alternating sequences of hard and soft segments or domains formed by the reaction of (1) diisocyanates with short-chain diols and (2) diisocyanates with long-chain diols. By varying the ratio, structure and/or molecular weight of the reaction compounds, an enormous variety of different TPUs can be produced. This allows the polymer structure to be finely tuned to the desired final properties of the material.

TPU is preferably used as a dispersion (TPU beads in water) for coating. During the drying process of the impregnate, the TPU reacts and is incorporated into the polymer matrix, for example the impregnate, during pressing. It is advantageous if the glass transition temperatures of the TPU are as low as possible so that the elastic properties are retained.

As already indicated above, a melamine-free resin-containing layer is applied to the underside of the paper layer. In the case of the paper layer, this melamine-free resin-containing layer acts as an adhesive layer or adhesive coating.

A phenol-formaldehyde resin (PF resin), phenol-lignin-formaldehyde resin (PLF resin) or a polyurethane (PU) can be used as the adhesive layer (or adhesive coating).

The phenol-formaldehyde resin (PF resin) or phenol-lignin-formaldehyde resin (PLF resin) can be applied to the underside of the paper layer as a liquid application or as a powder application.

In the case of a liquid application, PF resin or PLF resin with a solids content of 30 to 80% by weight, preferably of 40 to 60% by weight, for example 50% by weight, is used. The application quantity of the PF resin or PLF resin is of 30 to 100 g/m²fl, preferably of 40 to 80 g/m²fl, more preferably of 50 to 70 g/m²fl, such as 60 g/m²fl. The amount of PF resin or PLF resin applied is approx. of 20 to 30% by weight relative to the paper weight.

In the case of powder application, PF resin or PLF resin is applied in a quantity of 10 to 50 g/m², preferably of 20 to 40 g/m², more preferably of 25 to 35 g/m², such as 30 g/m². The powdered resin is applied to the carrier material by means of electrostatic charging and optionally melted-on. It can also be applied by powder coating using the tribo process. In this case, the powder to be applied is frictionally charged.

“Melting-on” in the sense of the present application means that the melamine-free resin layer is not yet fully polymerized, but rather that the polymerization is stopped at an intermediate stage in which further crosslinking or polymerization is still possible at a later processing time. The melting-on of the applied layer of powdered resin can be carried out using an IR emitter, microwave systems or similar. The use of IR emitters is particularly preferred.

In a further non-limiting embodiment, as an alternative to the phenol-formaldehyde resin, polyurethane is applied as at least one melamine-free adhesive layer or adhesive coating to the underside of the carrier material. The amount of the polyurethane adhesive coating is 10-40% by weight, preferably 20-30% by weight based on the weight of the paper.

After all layers have been applied to the paper layer, the resulting impregnate is dried to a defined residual moisture content, e.g. 5-10% by weight, preferably 6% by weight.

A paper layer coated and impregnated in this way, e.g. a decorative paper layer, can be pressed with a carrier board, e.g. a wood-based panel such as MDF or HDF or chipboard, in a short-cycle press or in a continuous press. For example, the impregnate can be cut to suitable formats and pressed onto wood-based panels.

In one non-limiting embodiment, the (upper) layer of thermoplastic elastomer can be coated with a layer of lacquer after pressing to increase abrasion resistance. For this purpose, a coating structure consisting of at least one coating layer and at least one top coat, preferably UV or ESH coating, is applied as a covering layer to improve scratch resistance. The top coat may contain nanoparticles, e.g. silica. No solvent-based lacquers are used.

For example, radiation-curable, acrylate-containing coatings are used for the coating layer and the top coat. Typically, the radiation-curable lacquers used contain (meth)acrylates, such as polyester (meth)acrylates, polyether (meth)acrylates, epoxy (meth)acrylates or urethane (meth)acrylates. It is also conceivable that the acrylate used or the acrylate-containing coating is present as substituted or unsubstituted monomers, oligomers and/or polymers, for example in the form of acrylic acid, acrylic ether and/or acrylic acid ester monomers, oligomers or polymers. Of importance for the present process is the presence of a double bond or unsaturated group in the acrylate molecule, as defined. The polyacrylates can also be functionalized. Suitable functional groups include hydroxyl, amino, epoxy and/or carboxyl groups. The acrylates mentioned enable crosslinking or curing in the presence of UV or electron beams (ESH).

The lacquer layer is applied in a quantity of 50 to 100 g/m², preferably of 60 to 80 g/m², while the top coat is applied in a quantity of 10 to 30 g/m², preferably 30 g/m². The coating structure can consist of at least one ESH coating layer, which is gelled after application with an ESH emitter, and at least one top coat, which is cured after application with an excimer emitter. The entire coating structure is then through-cured with an ESH lamp.

In one non-limiting embodiment, the present process thus comprises:
Providing at least one layer of paper as a carrier material,
Applying at least one layer of a urea-formaldehyde resin to the paper layer to impregnate the paper layer,
Applying at least one layer of a thermoplastic polyurethane to the upper side of the impregnated paper layer,
Applying at least one melamine-free adhesive layer to the underside of the impregnated paper layer, and
Drying and pressing of the layer structure,
Optional applying at least one lacquer to the at least one layer of thermoplastic polyurethane.

In a further non-limiting embodiment, the present process thus comprises:
Providing at least one layer of paper as a carrier material,
Applying at least one layer of a urea-formaldehyde resin to the paper layer to impregnate the paper layer,
Applying at least one layer of a thermoplastic polyurethane to the upper side of the impregnated paper layer,
Applying at least one powdery layer of a PF resin or PLF resin as a melamine-free adhesive layer to the underside of the impregnated paper layer and melting-on of the powdery layer,
Drying and pressing of the layer structure, and
Optional applying at least one lacquer to the at least one layer of thermoplastic polyurethane,
In another non-limiting embodiment, the present process thus comprises:
Providing at least one layer of paper as a carrier material,
Applying at least one layer of a urea-formaldehyde resin to the paper layer to impregnate the paper layer,
Applying at least one layer of a thermoplastic polyurethane to the upper side of the impregnated paper layer,
Applying at least one liquid layer of a PF resin or PLF resin as a melamine-free adhesive layer on the underside of the impregnated paper layer,
Drying and pressing of the layer structure,
Optional applying at least one lacquer to the at least one layer of thermoplastic polyurethane.

In yet another non-limiting embodiment, the present process thus comprises:
Providing at least one layer of paper as a carrier material,
Applying at least one layer of a urea-formaldehyde resin to the paper layer to impregnate the paper layer,
Applying at least one layer of a thermoplastic polyurethane to the upper side of the impregnated paper layer,
Applying at least one liquid layer of a polyurethane as a melamine-free adhesive layer on the underside of the impregnated paper layer,
Drying and pressing of the layer structure,
Optional applying at least one UV coating to the at least one layer of thermoplastic polyurethane.

Accordingly, the present process according to the first non-limiting aspect enables in one non-limiting variant the provision of a first melamine-free composite material with the following layer structure (from bottom to top):
melamine-free adhesive layer, preferably a layer of PF resin or PLF resin or polyurethane paper layer impregnated with urea-formaldehyde resin—layer of TPU—optional lacquer.

In a further non-limiting variant, the present process makes it possible to provide a melamine-free composite material with the following layer structure (from bottom to top):
Wood-based panel—melamine-free adhesive layer, preferably a layer of PF resin or PLF resin or polyurethane—paper layer impregnated with urea-formaldehyde resin—layer of TPU—optional lacquer.

As described above, it is also possible to omit the use of a thermoplastic elastomer for coating the surface and instead apply a coating structure to the layer structure after pressing.

According to the second non-limiting aspect, the present process may thus also comprise the following steps:
Providing at least one layer of paper,
Applying at least one layer of a urea-formaldehyde resin to the paper layer to impregnate the paper layer,
Applying at least one melamine-free resin-containing layer as an adhesive layer on the underside of the impregnated paper layer,
Drying and pressing of the layer structure, and
Applying at least one layer of lacquer to the upper side of the pressed layer structure.

In a further non-limiting embodiment, the present process thus comprises:
Providing at least one layer of paper as a carrier material,
Applying at least one layer of a urea-formaldehyde resin to the paper layer to impregnate the paper layer,
Applying at least one powdery layer of a PF resin or PLF resin as a melamine-free adhesive layer to the underside of the impregnated paper layer and melting-on of the powdery layer,
Drying and pressing of the layer structure, and
Applying at least one layer of varnish to the top of the pressed layer structure.

In another non-limiting embodiment, the present process thus comprises:
Providing at least one layer of paper as a carrier material,
Applying at least one layer of a urea-formaldehyde resin to the paper layer to impregnate the paper layer,
Applying at least one liquid layer of a PF resin or PLF resin as a melamine-free adhesive layer on the underside of the impregnated paper layer,
Drying and pressing of the layer structure, and
Applying at least one layer of varnish to the top of the pressed layer structure.

In yet another non-limiting embodiment, the present process thus comprises:
Providing at least one layer of paper as a carrier material,
Applying at least one layer of a urea-formaldehyde resin to the paper layer to impregnate the paper layer,
Applying at least one liquid layer of a polyurethane as a melamine-free adhesive layer on the underside of the impregnated paper layer,
Drying and pressing of the layer structure.
Applying at least one layer of lacquer to the top of the pressed layer structure.

The above details for the composition and application quantities of resin and varnish also apply to the latter embodiments of the second non-limiting aspect of the process.

Accordingly, the present process according to the second non-limiting aspect enables, in one non-limiting variant, the provision of a melamine-free composite material with the following layer structure (from bottom to top):
melamine-free adhesive layer, preferably a layer of PF resin or PLF resin or polyurethane paper layer impregnated with urea-formaldehyde resin—lacquer structure.

In a further non-limiting variant, the present process according to the second non-limiting aspect makes it possible to provide a melamine-free composite material with the following layer structure (from bottom to top):
Wood-based panel—melamine-free adhesive layer, preferably a layer of PF resin or PLF resin or polyurethane—paper layer impregnated with urea-formaldehyde resin—lacquer structure.

### Wood-Based Panel as Carrier Material

In another non-limiting embodiment of the present process, a wood-based panel, preferably a medium-density fiber (MDF), high-density fiber (HDF) plywood panel, a chipboard or a wood-plastic composite panel (WPC) is used as the carrier material. Particularly preferred wood-based panels are wood fiber boards with urea-formaldehyde glue as a binder, such as an HDF board with urea-formaldehyde glue.

Accordingly, the present process according to the first non-limiting aspect may also comprise:
Providing at least one wood-based panel as a carrier material,
Applying at least one layer of urea-formaldehyde resin to the upper side of the wood-based panel,
Applying at least one layer of at least one thermoplastic elastomer; for example of a thermoplastic polyurethane;
Applying at least one melamine-free backing, preferably in the form of a layer of PF resin or PLF resin, to the underside of the wood-based panel, and
Drying and pressing of the layer structure.

In a non-limiting embodiment, the present process comprises:
Providing at least one wood-based panel as a carrier material,
Applying at least one layer of urea-formaldehyde resin to the upper side of the wood-based panel,
Applying at least one colored base coat,
Applying at least a first primer layer,
Applying a print decoration;
Applying at least a second primer layer,
Applying at least one layer of at least one thermoplastic elastomer;
Applying at least one melamine-free backing, preferably in the form of a layer of a PF resin or PLF resin, to the underside of the wood-based panel as a backing, and
Drying and pressing of the layer structure.

Urea-formaldehyde resin is therefore used as a resin primer or rolling primer. The application quantity of the resin primer can be of 10 to 40 g resin fl/m², preferably of 20 to 30 g resin fl/m², e.g. 25 resin fl/m². The solids content of the resin primer can be of 20 to 50% by weight, preferably of 30 to 40% by weight, more preferably 35% by weight.

The urea-formaldehyde resin used for base coat is mixed with the usual additives such as hardeners, wetting agents (surfactants or mixtures thereof), release agents and/or other components.

The preferred color base coat is a composition of casein or soy protein as a binder and inorganic pigments, for example inorganic color pigments. White pigments such as titanium dioxide or other color pigments such as calcium carbonate, barium sulfate or barium carbonate can be used as color pigments in the primer layer. In addition to the color pigments and the casein or soy protein, the primer can also contain water as a solvent. It is also preferred if the applied pigmented base coat consists of at least one, preferably at least two, particularly preferably at least four, or up to seven successively applied layers or coats, whereby the application quantity between the layers or coats can be the same or different. The application quantity of the color base coat is 5-10 g primer fl/m² application and layer. Intermediate drying is preferred after each application.

The amount of liquid first primer applied to the color base coat primer is of 5 to 30 g/m², preferably of 10 to 20 g/m², more preferably of 10 to 15 g/m². Isocyanate-based compounds are preferred as primers, with non-aromatic, aliphatic isocyanates, such as hexamethylene diisocyanate, isophorone diisocyanate, or prepolymers containing these isocyanates being particularly preferred.

After a drying step, the decorative layer is applied. This is preferably done by direct printing. In the case of direct printing, a water-based, pigmented printing ink is applied using the gravure printing or digital printing process, whereby the water-based pigmented printing ink can be applied in more than one layer, e.g. in the form of two to ten layers, preferably three to eight layers. The gravure printing process is a printing technique in which the elements to be depicted are present as indentations in a printing form that is inked before printing. The ink is primarily located in the indentations and is transferred to the object to be printed, such as a wood fiber carrier board, due to the contact pressure of the printing form and adhesion forces. In digital printing, on the other hand, the printed image is transferred directly from a computer to a printing machine, such as a laser printer or inkjet printer. This eliminates the use of a static printing form. In both processes, the use of aqueous inks and inks or UV-based colorants is possible. It is also conceivable to combine the aforementioned gravure and digital printing techniques. A suitable combination of printing techniques can be carried out directly on the carrier plate or the layer to be printed or also before printing by adapting the electronic data sets used. The markings required for alignment in the press are also printed together with the decor.

The liquid second primer following the printed decor is applied with a solids content of 40 to 60% by weight, preferably of 45 to 55% by weight, for example preferably 50% by weight. The quantity of the second primer layer applied to the printed decoration can be of 10 to 40 g/m², preferably of 10 to 30 g/m², for example preferably 20 g/m². Isocyanate-based compounds are preferred as primers, with non-aromatic, aliphatic isocyanates, such as hexamethylene diisocyanate, isophorone diisocyanate, or prepolymers containing these isocyanates being particularly preferred.

In a further non-limiting variant of the process, a film made of thermoplastic elastomer, in particular a film made of thermoplastic polyurethane, is used as the thermoplastic elastomer layer.

The thickness of the film, in particular the TPU film, is of 50 to 150 μm, preferably of 80 to 120 μm, for example 100 μm. Several films can also be used, which are either applied individually during pressing or are already bonded together in an upstream step.

The thermoplastic film, e.g. TPU film, can also have a surface finish, e.g. with a lacquer, to achieve the desired properties. This can, for example, positively influence the behavior against scratching, chemical stress, abrasion, etc. A more positive behavior can also be achieved with regard to static charging, soiling, etc. by using a lacquer. The coating can be applied during the production of the film.

The TPU film used in the present case may also have abrasion-resistant particles, such as abrasion-resistant particles preferably selected from the group comprising aluminum oxides, boron carbides, silicon dioxides, silicon carbides and glass particles. Abrasion-resistant particles with grain sizes in classes F180 to F240, preferably F200 or F220, are preferably used. The grain size of class F180 covers a range of 53 to 90 μm, of class F220 covers a range of 45 to 75 μm, of class F230 covers a range of 34 to 82 μm, of class F240 covers a range of 28 to 70 μm (FEPA standard). The abrasion-resistant particles must not be too fine-grained (risk of dust formation), but also not too coarse-grained. The size of the abrasion-resistant particles is therefore a compromise.

In another further non-limiting variant of the process, a dispersion of a thermoplastic elastomer, for example a dispersion of a thermoplastic polyurethane, is applied as the thermoplastic elastomer layer. In this case, a dispersion, for example a TPU dispersion, with a solids content of 20 to 60% by weight, preferably of 30 to 50% by weight, for example 40% by weight, is used. The amount of thermoplastic elastomer applied is of 50 to 150 g/m²fl, preferably of 70 to 130 g/m²fl, more preferably of 90 to 110 g/m²fl, such as 100 g/m²fl,

As already described above, if the thermoplastic elastomer, for example TPU, is applied, the TPU layer can be provided with a coating layer after pressing to increase abrasion resistance. For this purpose, a coating structure consisting of at least one coating layer and at least one top coat, preferably UV coating, is applied as a covering layer to improve scratch resistance. The top coat can contain nanoparticles, e.g. of silicic acid. No solvent-based lacquers are used. Otherwise, please refer to the explanations above.

As already mentioned above, a melamine-free backing, for example in the form of a layer of PF resin or PLF resin, is applied to the underside of the wooden core board or wood-based panel. This compensates for example for the tensile forces exerted by the layers applied to the top side of the wood-based panel.

In a non-limiting embodiment, the melamine-free backing is designed as a cellulose layer (paper layer) that is impregnated with PF resin or PLF resin or also with urea-formaldehyde resin.

The PF resin or PLF resin as a melamine-free backing can also be applied in liquid form. In the case of a liquid application, PF resin or PLF resin with a solids content of 30 to 80% by weight, preferably of 40 to 60% by weight, for example 50% by weight, is used. The amount of phenol-formaldehyde resin applied is of 30 to 100 g/m²fl, preferably of 40 to 80 g/m²fl, more preferably of 50 to 70 g/m²fl, such as 60 g/m²fl.

As mentioned, the layer structures are pressed into a laminate in a single work step under the effect of temperature and pressure in a short-cycle press or in a continuously operating press.

Conventional short-cycle presses, for example, operate at a pressure of 30 to 60 kg/cm², a temperature on the surface of the wood-based material of around 160-195° C. and a pressing time of 10 to 30 seconds

Accordingly, in one non-limiting variant, the present process makes it possible to provide a melamine-free composite material with the following layer structure (from bottom to top):
Melamine-free backing, preferably made of PF resin or PLF resin-wood-based panel—at least one urea-formaldehyde resin primer—at least one layer of thermoplastic elastomer.

In a further non-limiting variant, the present process makes it possible to provide a melamine-free composite material with the following layer structure (from bottom to top):
Melamine-free backing, preferably made of PF resin or PLF resin-wood-based panel—at least one urea-formaldehyde resin primer—at least one color base coat—at least one first primer layer—at least one decorative layer applied by direct printing—at least one second primer layer—at least one thermoplastic polyurethane film.

In yet another non-limiting variant, the present process makes it possible to provide a melamine-free composite material with the following layer structure (from bottom to top):
Melamine-free backing, preferably made of PF resin or PLF resin-wood-based panel—at least one urea-formaldehyde resin primer—at least one color base coat—at least one first primer layer—at least one decorative layer applied by direct printing—at least one second primer layer—at least one layer of thermoplastic polyurethane-optional UV varnish.

The present disclosure is explained below using several examples.

### Example 1

A decor paper (paper weight: 80 g/m²) is impregnated with a urea resin on an impregnation line. The impregnation channel runs at a speed of 60 m/min. The application quantity is approx. 160 g/m²liquid, which corresponds to a solid application quantity of 80 g/m². The impregnating resin contains the usual additives such as hardener, wetting agent etc., Care must be taken to ensure that after impregnation the top and bottom of the decorative sheet are scraped off sharply using a squeegee.

After intermediate drying to a residual moisture content of approx. 20% by weight, a TPU dispersion is applied to the top side and a phenolic resin or a polyurethane dispersion to the reverse side using screens or rollers.

The PF resin or PLF resin or the PU dispersion was applied in a quantity of 60 g/m²fl. (solid: 50% by weight)

The TPU dispersion was applied at a rate of 100 g/m (2) (solids content: 40% by weight).

The impregnate is then dried to a residual moisture content of approx. 6% by weight. It is then cut or cut into sheets (format: 2800×2070 mm).

The impregnate is then pressed onto a chipboard (19 mm). A white decorative paper with the same paper grammage and the same resin coating is used as the reverse side. The pressing parameters were: P=40 kg/cm², t=20 sec and T (top/bottom)=180° C. The surface was tested in accordance with DIN EN 14322:2021 “Melamine faced panels for interior use”. The values required by the standard were achieved.

### Example 2

An HDF (format: 2800×2070×7 mm) is first base coated with a urea-formaldehyde resin in a direct printing line, which is operated at a speed of 80 m/min (application quantity: approx. 25 g urea-formaldehyde resin fl./m², solids content: approx. 35% by weight). The impregnating resin contains the usual additives such as hardener, wetting agent, etc. The resin is dried in a circulating air dryer.

A color base coat consisting of titanium dioxide and casein is then applied. This color base coat is applied up to seven times. The application quantity is 5-10 g primer per application. Intermediate drying is carried out after each application using a circulating air and/or IR dryer.

A primer is then applied (application quantity 10-20 g fl/m²). This is also dried.

A decor is then printed onto this primer using gravure or digital printing. The print is dried in a circulating air dryer.

An isocyanate-based primer is applied to the dried print (application quantity: approx. 20 g fl./m², solids content: approx. 50% by weight).

A TPU film (film thickness: 100 μm) is then applied to the top side of the sheets on a KT press. The TPU film contains approx. 15 g corundum/m² with a grain size of F200 in accordance with the FEPA standard.

A melamine-free backing is applied to the reverse side of the board, either in liquid form or as sheets. A phenolic resin is used as the impregnating resin for the backing.

The structure is then pressed in the KT press at T=160° C., p=40 kg/cm² and t=24 sec. After cooling, the adhesion (DIN EN ISO 2409-2013-06) of the film is first tested using a cross-cut test, after which the panels are cut into raw fixed masses and then provided with a glueless profile. The surface was tested in accordance with DIN EN 16511-2014: “Panels for floating installation—Semi-rigid, multilayer modular floor coverings (MMF) with abrasion-resistant top layer”. The requirements of service class 31 were achieved. Some important tests are listed in the following table.

| | | DIN EN 16511 |
|---|---|---|
| Examination | Result | Utilization class 31/32 |
| Abrasion resistance, IP | 1500 cycles | 600/1200 cycles |
| Procedure A | | |
| Shock resistance, large | 1600 mm | 800/1200 mm |
| ball | | |
| Stain resistance | | |
| Group 1 + 2 | Grade 5 | Grade 5 |
| Group 3 | Grade 4 | Grade 4 |
| Micro scratch resistance | — | —/MSR-A3 |
| Class | | |

### Example 3

A decor paper (paper weight: 80 g/m²) is impregnated with a urea resin on an impregnation line. The impregnation channel runs at a speed of 60 m/min. The application quantity is approx. 160 g/m²liquid, which corresponds to a solid application quantity of 80 g/m². The impregnating resin contains the usual additives such as hardener, wetting agent etc., Care must be taken to ensure that after impregnation, the top and bottom of the decorative sheet are scraped off sharply using a squeegee.

After intermediate drying to a residual moisture content of approx. 20% by weight, a phenolic powder resin or PLF powder resin is sprinkled onto the back of the impregnate using a spreader in an S-shape (30 g phenolic resin solid/m²).

A TPU dispersion is applied to the upper side using a roller applicator. The TPU dispersion was applied at a rate of 100 g/m (2) (solids content: 40% by weight). The impregnate is then dried to a residual moisture content of approx. 6% by weight.

It is then cut or cut into sheets (format: 2800×2070 mm). The impregnate is then pressed onto a chipboard (19 mm). A white decorative paper with the same paper grammage and the same resin coating is used as the reverse side. The pressing parameters were: p=40 kg/cm², t=20 sec and T (top/bottom)=180° C.

### Example 4

A decor paper (paper weight: 80 g/m²) is impregnated with a urea resin on an impregnation line. The impregnation channel runs at a speed of 60 m/min. The application quantity is approx. 160 g/m²liquid, which corresponds to a solid application quantity of 80 g/m². The impregnating resin contains the usual additives such as hardener, wetting agent etc., Care must be taken to ensure that after impregnation the top and bottom of the decorative sheet are scraped off sharply using a squeegee.

After intermediate drying to a residual moisture content of approx. 20% by weight, a phenolic resin is applied to the reverse side using grids or rollers.

The phenolic resin was applied in an amount of 60 g/m²fl. (solid: 50 wt %).

The impregnate is then dried to a residual moisture content of approx. 6% by weight. It is then cut or cut into sheets (format: 2800×2070 mm).

The impregnate is then pressed onto a chipboard (6 mm). A white decorative paper with the same paper grammage and the same resin coating is used as the reverse side. The pressing parameters were: P=40 kg/cm², t=20 sec and T (top/bottom)=180° C.

An isocyanate-based primer is applied to the impregnate surface (application quantity: approx. 20 g fl./m², solids content: approx. 50% by weight)

The panel is then coated in a coating line with a UV or ESH coating in several layers with intermediate curing. The lacquer layer is applied in a quantity of 30 g/m (2). The lacquer structure can consist of at least one ESH lacquer layer, which is cured after application with an ESH lamp, and at least one top coat, which is cured after application with an excimer lamp. The entire lacquer structure is then cured with an ESH lamp. The board is then cut into floorboards in a flooring line.
The present disclosure provides desired advantages, including the avoidance of labeling and the reaction to reclassification.

1. A process of producing a composite material free of melamine-formaldehyde resin comprising at least one carrier material, at least one polymer layer provided on the upper side of the carrier material and at least one resin-containing layer provided on the underside of the carrier material, comprising:
providing at least one carrier material,
applying at least one layer of a urea-formaldehyde resin to the upper side of the carrier material,
applying at least one layer of a thermoplastic elastomer, in particular thermoplastic polyurethane, to the upper side of the carrier material,
applying at least one melamine-free resin-containing layer to the underside of the carrier material, and
drying and pressing of the layer structure.

2. A process for producing a composite material free of melamine-formaldehyde resin comprising at least one carrier material, at least one lacquer layer provided on the upper side of the carrier material and at least one resin-containing layer provided on the underside of the carrier material, comprising:
providing at least one carrier material,
applying at least one layer of a urea-formaldehyde resin to the carrier material,
applying at least one melamine-free resin-containing layer to the underside of the carrier material, and
drying and pressing of the layer structure;
applying at least one layer of lacquer to the upper side of the pressed layer structure.

3. The process according to claim 1, wherein in the at least one carrier material is a paper layer.

4. The process according to claim 1, wherein the liquid application quantity of the urea-formaldehyde resin is of 100 to 250 g/m².

5. Th process according to claim 1, wherein a dispersion of a thermoplastic elastomer with a solids content of 20 to 60% by weight, is used and the application quantity of the thermoplastic elastomer is of 50 to 150 g/m²fl.

6. The process according to claim 1, wherein a melamine-free adhesive layer in the form of a phenol-formaldehyde resin, a phenol-lignin-formaldehyde resin or a polyurethane is applied to the underside of the carrier material as the resin-containing layer.

7. The process according to claim 6, wherein the phenol-formaldehyde resin or phenol-lignin-formaldehyde resin or the polyurethane is applied to the underside of the carrier material as a liquid application or as a powder application.

8. A melamine-free composite material producible in a process according to claim 1 comprising the following layer structure:
optional melamine-free adhesive layer—layer of phenol-formaldehyde resin or phenol-lignin-formaldehyde resin—paper layer impregnated with urea-formaldehyde resin—layer of TPU—optional lacquer.

9. The melamine-free composite material according to claim 8, comprising the following layer structure:
wood-based panel—melamine-free adhesive layer—layer of phenol-formaldehyde resin or phenol-lignin-formaldehyde resin—paper layer impregnated with urea-formaldehyde resin—layer of TPU—optional lacquer.

10. The process according to claim 1, wherein the at least one carrier material is a wood-based panel.

11. The process according to claim 10, comprising:
providing at least one wood-based panel as a carrier material,
applying at least one layer of urea-formaldehyde resin to the upper side of the wood-based panel,
applying at least one layer of at least one thermoplastic elastomer;
applying at least one melamine-free backing, preferably in the form of a layer of a phenol-formaldehyde resin or phenol-lignin-formaldehyde resin, to the underside of the wood-based panel, and
drying and pressing of the layer structure

12. The process according to claim 10, comprising:
providing at least one wood-based panel as a carrier material,
applying at least one layer of urea-formaldehyde resin to the upper side of the wood-based panel,
applying at least one color base coat;
applying at least a first primer coat,
applying a print decoration;
applying at least a second primer coat,
applying at least one layer of at least one thermoplastic elastomer;
applying at least one melamine-free backing, preferably in the form of a layer of a phenol-formaldehyde resin or phenol-lignin-formaldehyde resin, to the underside of the wood-based panel, and
drying and pressing of the layer structure

13. The process according to claim 10, wherein a film of thermoplastic polyurethane with a thickness of 50 to 150 μm, is used as the thermoplastic elastomer layer.

14-15. (canceled)

16. The process according to claim 2, wherein the at least one carrier material is a paper layer.

17. The process according to claim 2, wherein the liquid application quantity of the urea-formaldehyde resin is of 100 to 250 g/m².

18. The process according to claim 2, wherein a melamine-free adhesive layer in the form of a phenol-formaldehyde resin, a phenol-lignin-formaldehyde resin or a polyurethane is applied to the underside of the carrier material as the resin-containing layer.

19. The process according to claim 18, wherein the phenol-formaldehyde resin or phenol-lignin-formaldehyde resin or the polyurethane is applied to the underside of the carrier material as a liquid application or as a powder application.

20. The process according to claim 1, wherein the at least one carrier metal is a medium density fibreboard (MDF).

21. The process according to claim 1, wherein the at least one carrier metal is a high density fibreboard (HDF) or chipboard.

22. The process according to claim 1, wherein the at least one carrier metal is a plywood panel or a wood plastic composite panel (WPC).
